(19) United States
(12) Patent Application Publication
(10) Pub. No.: US 2012/0255020 A1
(43) Pub. Date: Oct. 4, 2012

(54) METHODS FOR ATTACK SURFACE MEASUREMENT

(75) Inventors: Allan James Stoneham, Cumbernauld (GB); Tyn Ong, Livingston (GB); Sozon Kokkinaras, Edinburgh (GB); Peny Laurent, Bathgate (GB); Andrew Ireland, Hamilton (GB)

(73) Assignee: General Electric Company, Schenectady, NY (US)

(21) Appl. No.: 13/073,976

(22) Filed: Mar. 28, 2011

(51) Int. Cl. G08B 23/00

(52) U.S. Cl. 726/25

(57) ABSTRACT

Methods and apparatus are provided for measuring the attack surface of a code library. In one embodiment, a method includes measuring the attack surfaces of a compiled code library, counting the number of each public item of a plurality of items of the compiled code library, and displaying a visualization of the measurement, wherein the visualization identifies each item type of the plurality of items of the compiled code library and the measurement of each item of the plurality of items of the compiled code library.

### BACKGROUND OF THE INVENTION

The subject matter disclosed herein relates to electronic devices having executable code and, more particularly to evaluating the security of the executable code.

Electronic devices are generally employed in numerous configurations to provide a variety of computing functions. For example, electronic devices may include personal computer systems (e.g., desktop laptop, and tablet computers), as well as, commercial systems (e.g., servers or industrial computers). In the field of computing, ensuring the security of electronic devices and the programs executed by such devices is a primary concern. The electronic devices and programs may be threatened and possibly infected by malware such as viruses, trojan horses, spyware, adware, etc. One avenue for infection of electronic devices and programs are the actual programs themselves. Such programs may be attacked by malware or malicious personnel through security vulnerabilities present in the programs.

### BRIEF DESCRIPTION OF THE INVENTION

In one embodiment, a method includes measuring the attack surfaces of a compiled code library by counting a number of each public item of a plurality of items of the compiled code library to obtain a measurement and displaying a visualization of the measurement, wherein the visualization identifies each item type of the plurality of items of the compiled code library and the measurement of each item of the plurality of items of the compiled code library.

In another embodiment, a non-transitory tangible machine-readable medium is provided with code having instructions for measuring the attack surfaces of a compiled code library by counting the number of each public item of the compiled code library to obtain a measurement and displaying a visualization of the measurement, wherein the visualization identifies each item type of the compiled code library and the measurement of each item type of the compiled code library.

In another embodiment, a non-transitory tangible machine-readable medium is provided with code having instructions for identifying one or more code libraries for an attack surface measurement, weighting each item of the one or more code libraries for the attack surface measurement, measuring the attack surfaces of the one or more code libraries, and displaying weighted results of the attack surfaces of the one or more code libraries.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a processor-based system in accordance with an embodiment of the present invention;

FIG. 2 is a block diagram of a code library and an attack surface measurement application in accordance with an embodiment of the present invention;

FIG. 3 is a flowchart of a process for attack surface measurement of code libraries in accordance with an embodiment of the present invention;

FIG. 4 is a depiction of a configuration file for an attack surface measurement application in accordance with an embodiment of the present invention; and

FIGS. 5-7 depict visualizations of the results of an attack surface measurement of code libraries in accordance with embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention include techniques for measuring the code attack surface of compiled code libraries and providing visualizations of the measurement results. In an embodiment, an attack surface measurement application may count the number of public items of each item of targeted compiled code libraries. The attack surface measurement application may be configured by providing the target path of the compiled code libraries, the excluded code libraries, the number of opportunities, and the weighting of each item type. Additionally, in an embodiment, the measurement results may be displayed in a visualization having a text format, a graphic format, or a combination thereof. The graphic format may include bar graphs, stacked bar graphs, area 3D graphs, or a combination thereof.

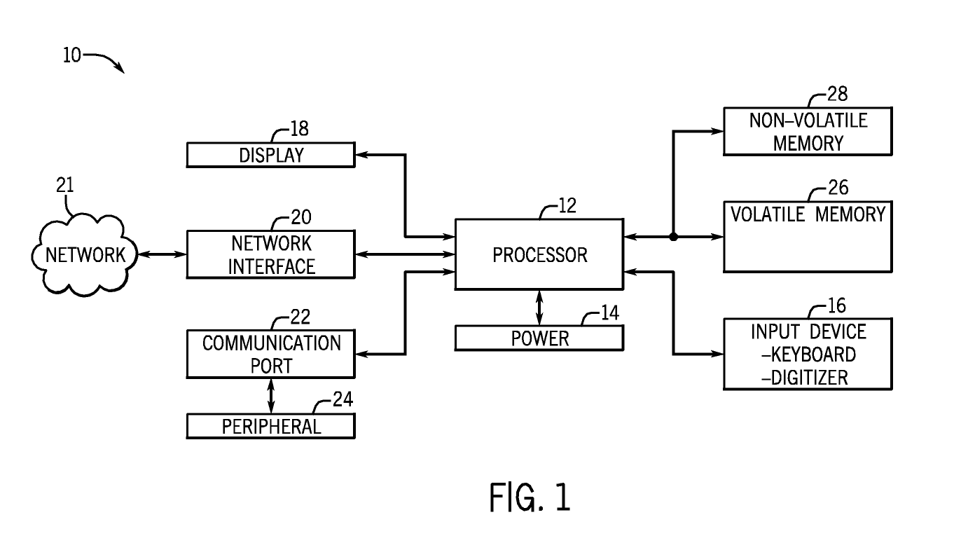

Turning now to the figures, FIG. 1 is a block diagram that depicts a processor-based system (e.g., an electronic device), generally designated by reference numeral 10. The system 10 may be any of a variety of types such as a computer, tablet computer, pager, cellular phone (e.g., a smartphone), personal organizer, control circuit, or the like. In a typical processor-based system, one or more processors 12, such as a microprocessor, control the processing of system functions and requests in the system 10.

The system 10 typically includes a number of components. For example, in the illustrated embodiment, the system 10 includes a power supply 14. If the system 10 is a portable system, the power supply 14 may advantageously include permanent batteries, replaceable batteries, and/or rechargeable batteries. The power supply 14 may also include an AC adapter, so the system 10 may be plugged into a wall outlet, for instance. The power supply 14 may also include a DC adapter such that the system 10 may be plugged into a vehicle cigarette lighter, for instance. Various other devices may be coupled to the processor 12 depending on the functions that the system 10 performs. In the illustrated embodiment, a user interface 16 is coupled to the processor 12. The user interface 16 may include buttons, switches, a keyboard, a light pen, a mouse, and/or a voice recognition system, for instance. A display 18 is coupled to the processor 12 in the illustrated embodiment. The display 18 may include a liquid crystal display (LCD) display, a cathode ray tube (CRT), light emitting diodes (LEDs), a touchscreen, and/or an audio display, for example. Furthermore, one or more network interfaces 20 may be coupled to the processor 12. The network interfaces 20 may include a wired interface, a wireless interface, or a combination thereof, and may provide for communication over any suitable network type. For example, the network interface may include Ethernet, wireless Ethernet, or cellular networks. As shown in FIG. 1, the system 10 may be coupled to a network 21 via the network interface 21. The network 21 may be any suitable network such as, for example, the Internet, an intranet, a wide area network (WAN), local area network (LAN).

Communication ports 22 may also be coupled to the processor 12. The communication port 22 may be adapted to be coupled to peripheral devices 24, such as a modem, a printer, a computer, or to a network, such as a local area network, remote area network, intranet, or the Internet, for instance.

The processor 12 generally controls the system 10 by implementing software programs stored in the memory. The memory is operably coupled to the processor 12 to store and facilitate execution of various programs. For instance, the processor 12 may be coupled to a volatile memory 26, which may include Dynamic Random Access Memory (DRAM) and/or Static Random Access Memory (SRAM). The volatile memory 26 may store dynamically loaded applications and data.

The processor 12 may also be coupled to non-volatile memory 28 and may communicate with the non-volatile memory 28. The non-volatile memory 28 may include a read-only memory (ROM), such as an EPROM, and/or flash memory to be used in conjunction with the volatile memory. The size of the ROM is typically selected to be just large enough to store any operating system, application programs, and fixed data. Additionally, the non-volatile memory 28 may include a tape drive or hard disk drive.

In certain embodiments, the non-volatile memory 28 may store executable code (e.g., instructions) written in any suitable programming language. For example, such programming languages may include object-oriented programming languages such as Java, C#, C++, or other languages. In some embodiments, the code may be stored as a compiled code library. These code libraries may include various items used by other programs, such as the operating system of the system 10 and applications. Such code libraries may be referred to as “assemblies.” For example, in one embodiment, the compiled code library may be .NET assembly and may be stored as a dynamic linked library (DLL) file.

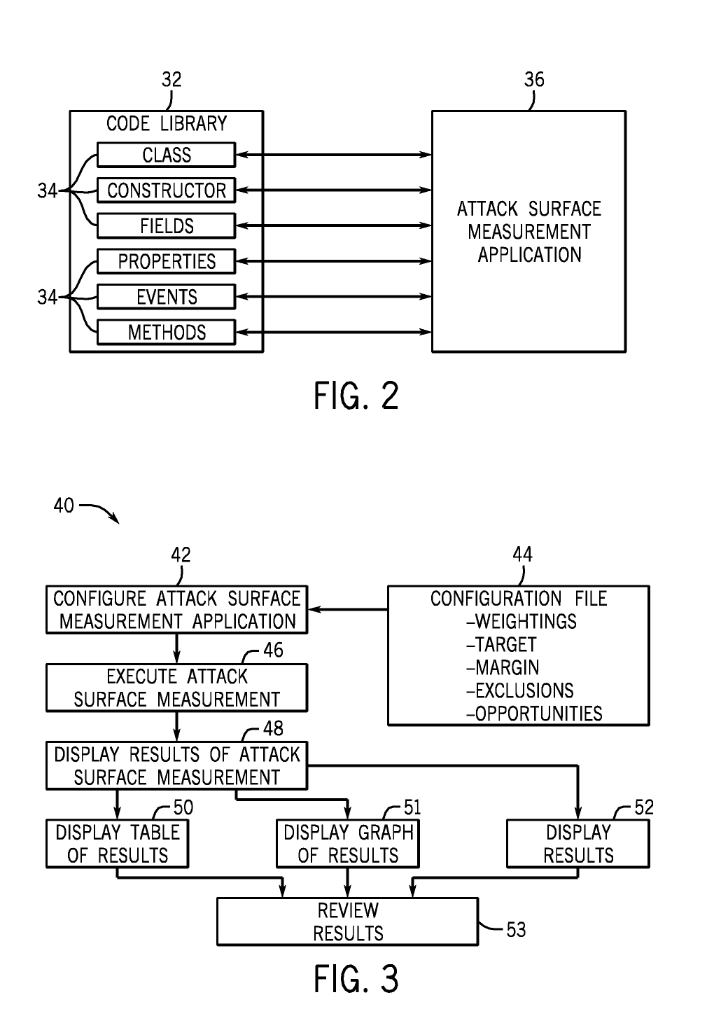

A code library may include several items that may be susceptible to attacks from malware or other programs. FIG. 2 depicts a code library 32 having various items 34 and an attack surface measurement application 36 in accordance with an embodiment of the present invention. The code library 32 may be stored on media accessible to the system 10, such as on the non-volatile memory 28 and the volatile memory 26. In other embodiments, the code library 32 may be accessible over the network 21.

As shown in FIG. 2, such items 34 may include classes, constructors, fields, properties, events, and methods of the code library. Some of these items 34 may be externally visible or accessible and may be susceptible to malware. These externally visible or accessible elements may be referred to as “surfaces” and may be visible to other programs referencing the code library. The attack surface measurement application 36 may measure the code attack surface of the code library by examining the items 34. The code attack surface measurement application 36 may count the number of externally visible items within the code library 32 and provide a visualization of the measurement. Additionally, as described below, the attack surface measurement application 36 may be configured using different parameters such as, for example, to assign weights to different items, to exclude certain code libraries, and specify a number of opportunities, as described below. As described above, in one embodiment, the code library 32 may be a .NET assembly and may be stored as a dynamic linked library (DLL) or executable (EXE) file. In such an embodiment, the attack surface measurement application 36 may use the .NET framework reflection library to measure the attack surfaces of items of a .NET assembly. The attack surface measurement application 36 may be used as a standalone application or the attack surface measurement may be incorporated into an existing application or software package, such as a module.

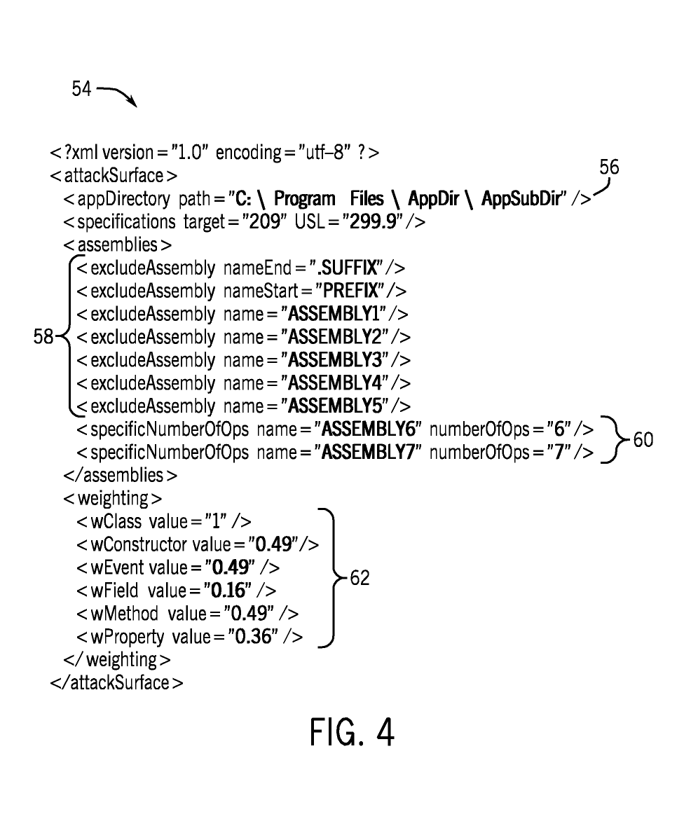

FIG. 3 depicts a process 40 for measuring the code attack surface of the code library 32 by the attack surface measurement application 36 in accordance with an embodiment of the present invention. The steps described in the process 38 may be as executable code stored on a non-transitory tangible machine-readable medium, such as the non-volatile memory 28 and the volatile memory 26. Initially, the attack surface measurement application 36 may be configured (block 42) to set, for example, the target location, the weightings of items in the measured assemblies, the excluded assemblies, and the number of opportunities for a given assembly. The target location may be specified for code libraries stored on media accessible to the system 10, such as on the non-volatile memory 28 and the volatile memory 26. In other embodiments, the target location may specify a network location accessible over the network 21. The configuration for the attack surface measurement application may be set and read from a configuration file (block 44). The configuration file may be an extensible markup language (XML) file and is described further below in FIG. 4.

Next, the attack surface measurement may be performed (block 46). As described, the attack surface measurement may measure the externally visible items of the targeted assemblies. The externally visible items may be counted and, in some embodiments, may be weighted based on the parameters in the configuration file 44, as described below. After measuring the code attack surface of the targeted assemblies, the results may be displayed in different formats (block 48). The results may be displayed as a table (block 50) and/or in a graphical format (block 51). As described below, the displayed results may include the counts, the weighted results, and one or more graphs to enable comparison between items.

Additionally, in some embodiments, the measurement results may be exported to another format or program (block 52). For example, the results may be exported to Microsoft Excel, to XML, to HTML, or to other suitable programs or formats. After the measurement, the measurement results may be reviewed (block 53) and appropriate action may be taken. For example, the code libraries may be reviewed to determine the necessity of the identified attack surfaces and the code library may be changed to reduce the extent of its attack surface.

FIG. 4 depicts a configuration file 54, e.g., an XML file, for configuring the attack surface measurement application 36. The configuration file 54 may be stored on non-transitory tangible machine-readable media, such as the non-volatile memory 28 and the volatile memory 26. As described below, the configuration file 54 may specify the location 56 of the code libraries (e.g., assemblies) to be measured, the excluded code libraries (e.g., assemblies) 58, the number of opportunities 60 per code library (e.g., assembly), and weights 62 of each item of the code library (e.g., assembly).

As shown in FIG. 4, the location 56, such as the directory path of the assemblies to be measured may be specified using, for example, the “path” attribute of the <appDirectory> tag. For example, as illustrated in FIG. 4, the location is specified as “C:\Program Files \AppDir\AppSubDir.” The configuration file 40 may also include a <Specifications> tag 63 that defines acceptable levels for the attack surface measurement that will be used in displaying the results. For example, the “target” attribute may set the acceptable value and the “USL” (Upper Specification Limit) attribute may set the upper limit for acceptable values. As described below, when the results of the attack surface measurement is displayed, those items having measurements below the “target” may be displayed in a first color (e.g., green), those items having measurements above the “target” but below the “USL” may be displayed in a second color (e.g., orange), and those items having measurements above the “USL” may be displayed in a third color (e.g., red). The configuration 40 may also specify excluded assemblies 44 using, for example, the <excludeAssembly> tag within the <assemblies> tag. The configuration file 54 may use different techniques for identifying the excluded assemblies. For example, the excluded assemblies may be excluded from attack surface measurement by specifying the suffix of each assembly name, such as by using the “nameEnd” attribute of the <excludeAssembly> tag. For example, as shown in FIG. 4, the “nameEnd” attribute specifics a suffix of “.SUFFIX.” Additionally, the excluded assemblies may be identified by specifying the prefix of each assembly name, such as by using the “nameStart” property of the <excludeAssembly> tag. For example, as shown in FIG. 4, the “nameStart” attribute specifics a prefix of “PREFIX.”

Additionally, excluded assemblies 58 may be excluded by identifying the full name of the assembly using the “name” attribute of the <excludeAssembly> tag. For example, as shown in FIG. 4, the assemblies “ASSEMBLY1,” “ASSEMBLY2,” “ASSEMBLY3,” “ASSEMBLY4,” and “ASSEMBLY5” are excluded from the attack surface measurement. Additionally, the number of opportunities for a measured assembly may be specified using, for example, the “name” attribute of the <specificNumberOfOps> tag to identify an assembly and the “numberOfOps” attribute to specify the number of opportunities for that assembly. As shown in FIG. 4, for example, 6 opportunities are specified for “ASSEMBLY6” and 7 opportunities are specified for “ASSEMBLY7.” The number of opportunities provides for offsetting the measurement based on the specified number. For example, the number of opportunities may correspond to the number of applications that can be used to attack a specific code library (e.g., assembly). The default value may be one opportunity per assembly but, as described above, more opportunities may be specified for a given assembly. The measured attack surfaces for a code library (e.g., assembly) may be divided by the number of opportunities to determine the average number of defects per opportunity in the code library.

As also mentioned above, the weights 62 of each item type of the measured assemblies may be specified, within, for example, the <weighting> tag. The weighting may be used in producing the results for each item type of each assembly. For example, tags <wClass>, <wConstructor>, <wEvent>, <wField>, <wMethod>, and <wProperty> may correspond to items Class, Constructor, Event, Field, Method, and Property respectively. The “value” attribute for each weighting tag may specify the weight given to that item type during the attack surface measurement. For example, as shown in FIG. 4, the class item has a weighting of 1, the constructor item has a weighting of 0.49, the event value has a weighting of 0.49, and so on.

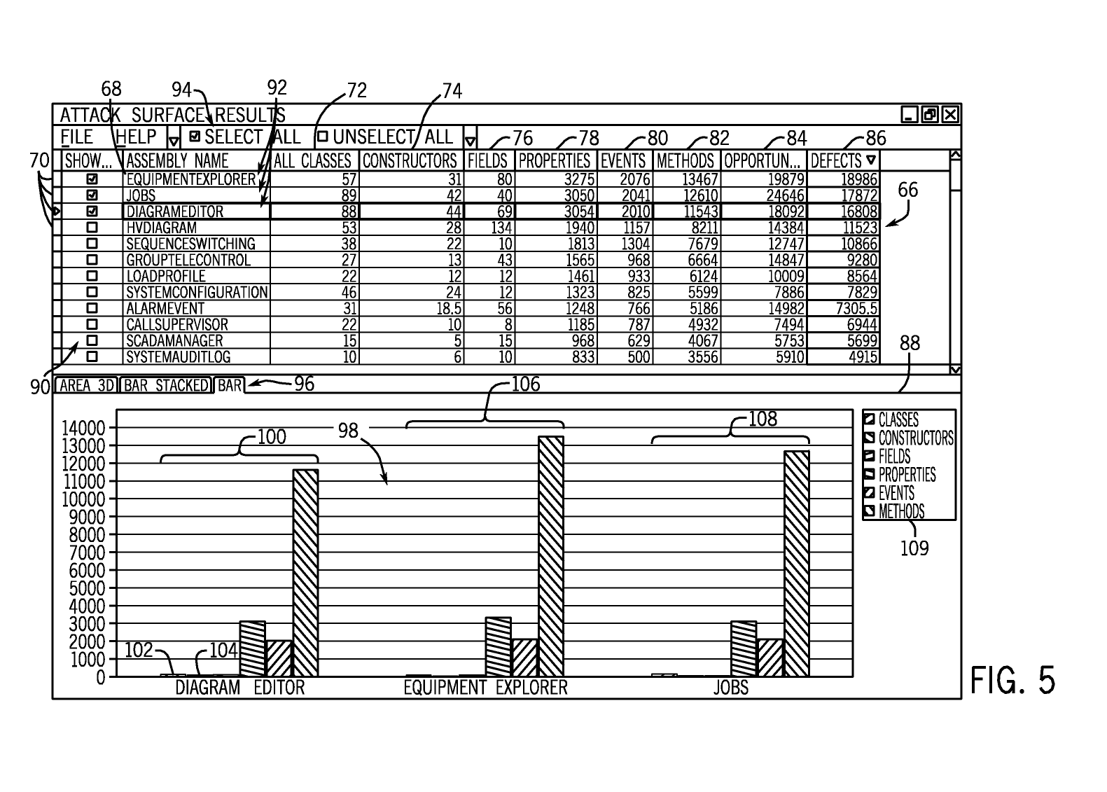

FIGS. 5-7 depict visualizations of the results of the attack surface measurement described above in accordance with an embodiment of the present invention. As shown in each of FIGS. 5-7, the results of the attack surface measurement of the targeted assemblies may be displayed in a text format, e.g., table 66. In other embodiments, the text format may include a list or other suitable text format.

As shown in FIGS. 5-7, the table 66 may have a first column 68 that displays the name of each targeted assembly measured by the attack surface measurement application. Each row 70 of the table 66 provides the measurement results for each item of that assembly. For example, column 72 provides the number of attack surfaces for classes, column 74 provides the number of measured attack surfaces for constructors, column 76 provides the number of measured attack surfaces for fields, column 78 provides the number of measured attack surfaces for properties, column 80 provides the number of measured attack surfaces for events, and column 82 provides the number of measured attack surfaces for methods. The table 66 may provide additional information such as the number of opportunities for an assembly, as shown in column 84, and the total number of defects per million opportunities of an assembly, as shown in column 86. As described above, the number of defects may be determined by dividing the measured attack surfaces by the number of opportunities specified for a given code library. In other embodiments, additional information may be determined and displayed based on any desired metric.

Additionally, the attack surface measurement application may provide for graphical display of the results. For example, as shown in FIGS. 5-7, the results of the attack surface measurement of the targeted assemblies may be displayed in a graphical format in graphics pane 88. The graphics pane 88 may display the results for assemblies selected from the table 66. The first column 90 of the table 66 may include checkboxes that allow selection of the assemblies to be displayed in the graphics pane 88. For example, as shown in FIGS. 5-7, the selected assemblies 92 may include the “EquipmentExplorer,” “Jobs,” and “DiagramEditor” assemblies. Additionally, checkboxes 94 are provided that enable “Select All” and “Unselect All” functions.

Once selected, the selected assemblies 92 from the table 66 are displayed in a selected graphical format in the graphics pane 88. The graphics pane 88 may include selected formats, e.g., tabs 96, to select the graphics format. For example, as shown in FIG. 5, the “Bar” tab may be selected to display a bar graph 98 in the graphics pane 88. The bar graph 98 may display each item of the selected assemblies 92. For example, the first group 100 of bars displays the attack surface count for each item of the “DiagramEditor” assembly. The first bar 102 displays the attack surface count for the classes of the “DiagramEditor” assembly (from column 72), the second bar 104 displays the attack surface count for constructors of the “DiagramEditor” assembly, and so on. In this manner, the attack surface measurement results for the selected assemblies are displayed in graphics pane 88. As also shown, for example, the second group 106 of bars displays the item attack surface count for each item of the “Jobs” assembly and the third group 108 of bars displays the item attack surface count for each item of the “EquipmentExplorer” assembly. In some embodiments, the bars of each group 100, 106, and 108 may be color-coded according to a threshold value. The threshold value may correspond to the number of attack surfaces for an item. For example, those items whose measurements are below the threshold may be colored green, those items whose measurements are within a specified margin of the threshold may be colored orange, and those items whose measurements exceed the threshold may be colored red. In other embodiments, the bars of each group may be arbitrarily color coded. Additionally, a legend 109 may be provided to aid in identification of the displayed item measurements.

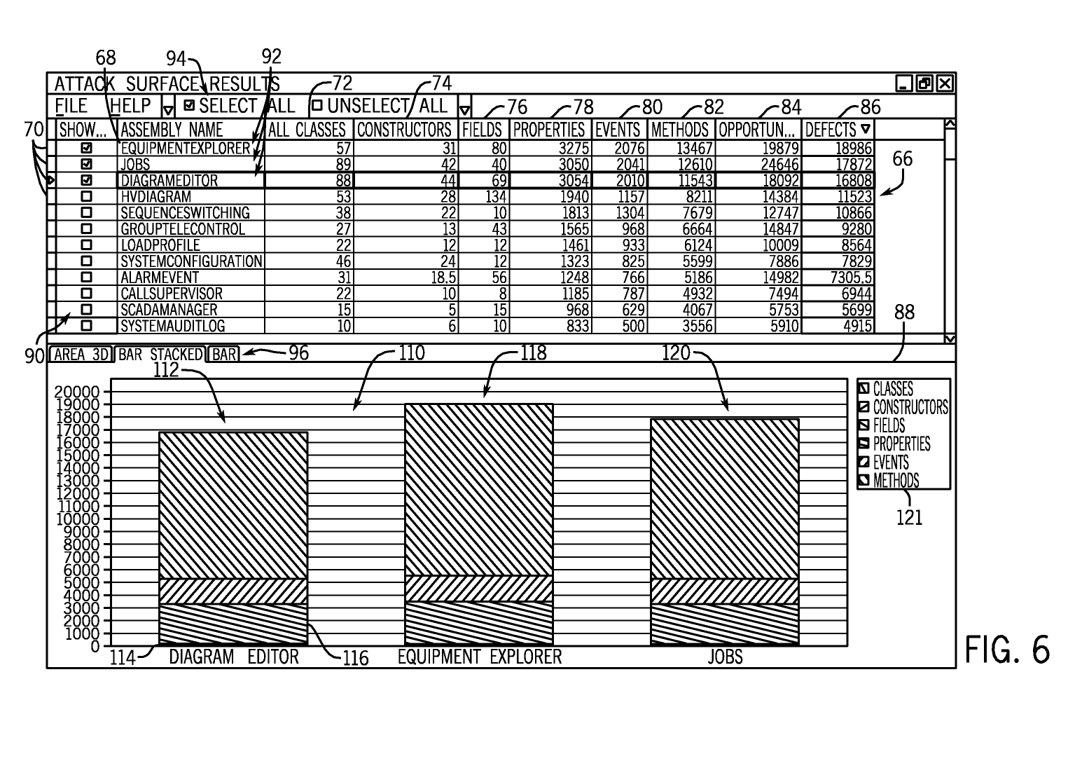

Additionally, other graphical formats may be displayed in the graphics pane 88 by selecting the other tabs 96. As shown in FIG. 6, the “Bar Stacked” tab 96 may be selected to display a stacked bar graph 110 in the graphics pane 88. The stacked bar graph 110 may display each item of the selected assemblies 92. For example, the first stack 112 of bars displays the attack surface count for each item of the “DiagramEditor” assembly. The first visible stack 114 displays the attack surface count for the fields of the “DiagramEditor” assembly (from column 72), the second stack 116 displays the attack surface count for properties of the “DiagramEditor” assembly, and so on. As also shown in FIG. 6, the second group 118 of stacked bars displays the item attack surface count for each item of the “Jobs” assembly and the third group 120 of stacked bars displays the item attack surface count for each item of the “EquipmentExplorer” assembly. As described above, in some embodiments, the bars of each stack 112, 118, and 120 may be color-coded according to a threshold value that may correspond to the number of attack surfaces for an item. For example, those items whose measurements are below the threshold may be colored green, those items whose measurements are within a specified margin of the threshold may be colored orange, and those items whose measurements exceed the threshold may be colored red. In other embodiments, the bars of each group may be arbitrarily color coded. Additionally, a legend 121 may be provided to aid in identification of the displayed item measurements.

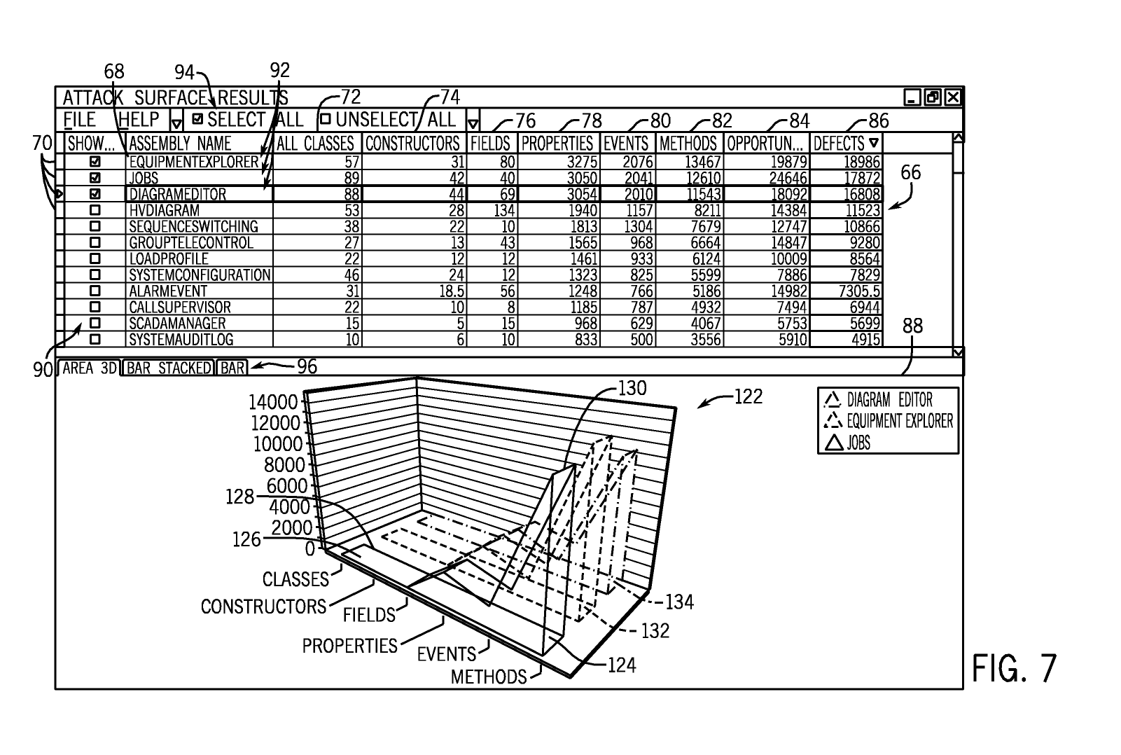

Finally, as shown in FIG. 7, the “Area 3D” tab 96 may be selected to display a three-dimensional graph 122 in the graphics pane 88. The three-dimensional graph 122 may display each item of the selected assemblies 92 in a three-dimensional format, wherein the height corresponds to the measured counts for each item, with the graph 122 depicting the results from lowest count to highest count. For example, the first 3D bar 124 displays the attack surface count for each item of the “EquipmentExplorer” assembly. The first portion 126 displays the attack surface count for the classes of the “EquipmentExplorer” assembly (from column 72), the second portion 128 displays the attack surface count for constructors of the “DiagramEditor” assembly, and so on. The highest portion 130 of the bar 124 displays the attack surface count for the methods of the “EquipmentExplorer” assembly (from column 82). As also shown in FIG. 7, the second 3D bar 132 of stacked bars displays the item attack surface count for each item of the “Jobs” assembly, and the third 3D bar 134 of stacked bars displays the item attack surface count for each item of the “EquipmentExplorer” assembly. Each selected assembly may be color-coded to distinguish the assemblies. For example, the first 3D bar 124 may be coded a first color, the second 3D bar 132 may be coded a second color, and the third 3D bar 134 may be coded a third color.

Technical effects of the invention include the measurement of the attack surfaces of a code library. Additional technical effects include the visualization of the results of the measurement, including visualization in a text format and a graphical format.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
measuring the attack surfaces of a compiled code library, comprising:
counting a number of each public item of a plurality of items of the compiled code library to obtain a measurement; and
displaying a visualization of the measurement, wherein the visualization identifies each item type of the plurality of items of the compiled code library and the measurement of each item of the plurality of items of the compiled code library.

2. The method of claim 1, wherein the compiled code library comprises a .NET assembly.

3. The method of claim 1, wherein the plurality of items comprise classes, constructors, fields, properties, events, and methods.

4. The method of claim 1, wherein displaying the visualization comprises displaying the number of opportunities of the compiled code library.

5. The method of claim 1, wherein measuring the attack surfaces of a compiled code library comprises weighting each item of the plurality of items.

6. The method of claim 1, wherein displaying the visualization comprises displaying a table identifying the compiled code library, each item type of the plurality of items of the compiled code library and the measurement of each item of the plurality of items of the compiled code library.

7. The method of claim 1, wherein displaying the visualization comprises displaying a graphical format identifying the compiled code library, each item type of the plurality of items of the compiled code library and the measurement of each item of the plurality of items of the compiled code library.

8. The method of claim 7, wherein the graphical format comprises a bar graph, a stacked bar graph, or a three-dimensional graph.

9. The method of claim 7, wherein the graphical format comprises a color-coded visualization of the measurement of each item of the plurality of items of the compiled code library.

10. A non-transitory tangible machine-readable medium comprising code stored thereon, the code comprising instructions for:
measuring the attack surfaces of a compiled code library by counting a number of each public item of the compiled code library to obtain a measurement; and
displaying a visualization of the measurement, wherein the visualization identifies each item type of the compiled code library and the measurement of each item type of the compiled code library.

11. The non-transitory tangible machine-readable medium of claim 10, wherein the compiled code library comprises a .NET assembly.

12. The non-transitory tangible machine-readable medium of claim 10, wherein the plurality of items comprise classes, constructors, fields, properties, events, and methods.

13. The non-transitory tangible machine-readable medium of claim 10, wherein displaying the visualization comprises displaying a graphical format identifying the compiled code library, each item type of the plurality of items of the compiled code library and the measurement of each item of the plurality of items of the compiled code library.

14. A non-transitory tangible machine-readable medium comprising code stored thereon, the code comprising instructions for:
identifying one or more code libraries for an attack surface measurement;
weighting each item of the one or more code libraries for the attack surface measurement;
measuring the attack surfaces of the one or more code libraries;
displaying weighted results of the attack surfaces of the one or more code libraries.

15. The non-transitory tangible machine-readable medium of claim 14, the code further comprising instructions for excluding a second one or more code libraries from the attack surface measurement.

16. The non-transitory tangible machine-readable medium of claim 15, the code further comprising instructions for receiving configuration parameters from a configuration file.

17. The non-transitory tangible machine-readable medium of claim 16, wherein the configuration file identifies the one or more code libraries for attack surface measurement and specifies the weighting of each item of the one or more code libraries.

18. The non-transitory tangible machine-readable medium of claim 16, wherein the configuration file identifies the second one or more code libraries for exclusion from the attack surface measurement.

19. The non-transitory tangible machine-readable medium of claim 14, wherein the configuration file comprises an XML file.

20. The non-transitory tangible machine-readable medium of claim 14, wherein displaying weighted results of the attack surfaces of the one or more code libraries comprises displaying the weighted results in a text format, a graphical format, or a combination thereof.
